(19) United States
(12) Patent Application Publication
(10) Pub. No.: US 2023/0276539 A1
(43) Pub. Date: Aug. 31, 2023

(54) HEATABLE COMPONENT AND METHOD FOR THE PRODUCTION THEREOF

(71) Applicant: Markus VILLINGER, Telfes (AT)

(72) Inventor: Markus VILLINGER, Telfes (AT)

(21) Appl. No.: 18/007,216

(22) PCT Filed: Jul. 28, 2021
(86) PCT No.: PCT/AT2021/060260

§ 371 Date: Jan. 27, 2023

(30) Foreign Application Priority Data
Jul. 28, 2020 (AT) A 50643/2020

(51) Int. Cl. H05B 3/34; H05B 3/06; H05B 3/16; H05B 3/18

(52) U.S. Cl. CPC H05B 3/342; H05B 3/06; H05B 3/16; H05B 3/18; H05B 2203/017

(57) ABSTRACT

The invention relates to a heatable component having a main body, a heating layer located on the main body and/or integrated in the main body for electrically heating the component, and electrical contacts for contacting the electrically heatable heating layer. The heating layer has at least one extension which is folded over onto a rear face or end face of the main body, and the electrical contacts are located on that part of the at least one extension which is located on the rear face or end face of the main body.

### TECHNICAL FIELD

The present invention relates to a component having the features of the preamble of claim 1 and a method for producing such a component.

### BACKGROUND OF THE INVENTION

Therefore, the invention particularly relates to components having a base member, a heating layer for electrically heating the component and electrical contacts for contacting the electrically heatable heating layer, wherein a heating layer which is arranged on the base member and/or which is integrated in the base member is provided for electrically heating the component.

In many industrial production processes, components to be produced have both to be able to be heated and to comply with - sometimes high - requirements with respect to a, for example, particularly smooth surface quality.

An example of where this could not yet be satisfactorily achieved in the current prior art would be heating units of specific components which are used in a cab, for example, of an aircraft, ship, rail vehicle or road vehicle, and which, to this end, for example, in order to achieve an improved or optimized energy efficiency, are intended to be positioned very near the surface. This means that the heating is intended to be delimited, for example, only by a thin decorative layer, for example, a film, a layer of leather or a coating, in the direction toward the outer side, and should ensure a smooth outer face and haptics which are as free from disruptions as possible.

Another example would be heating units which are intended to be positioned very near the surface, for example, for an improved or optimized energy efficiency and wherein at the same time the outer side of the surface should be continuously flat, for example, for technical reasons. Such technical reasons can be provided, for example, because a flush closure with respect to a support face is intended to be ensured, as can be the case in battery heating units or in a cab.

However, wires or the like which act as such a heating unit or at least as contacts for the heating unit invariably have an often undesirable influence on the surface to be heated (which is referred to here as the front side) as a result of the inherent thickness thereof..

### SUMMARY OF THE INVENTION

Therefore, the object of the invention is to provide a heatable component and a method for the production thereof, wherein the influence of the heating on the surface structure of the component is minimized, particularly eliminated.

This object is achieved by a component having the features as claimed. This is brought about by the heating layer having at least one extension which is bent over onto a rear side or front side of the base member and the electrical contacts being arranged at the portion of the at least one extension which is located at the rear side or the front side of the base member.

With respect to the method, on the one hand, the object is achieved by the claimed features, wherein
a base member is provided,
an electrically heatable heating layer which is provided with at least one extension is applied to a front side of the base member,
the at least one extension is bent over onto a rear side or a front side of the base member or the heating layer is applied to the base member with the at least one extension in the bent-over state, and
the heating layer is contacted at the portion of the at least one extension which is located on the rear side or front side of the base member.

With respect to the method, on the other hand, the object is achieved by the claimed features, wherein
a base member is provided,
an electrically heatable heating layer which is provided with at least one extension is integrated in the base member,
the at least one extension is bent over onto a rear side or front side of the base member or the heating layer is integrated in the base member with the at least one extension in the bent-over state, and
the heating layer is contacted at the portion of the at least one extension which is located on the rear side or front side of the base member.

In the context of the invention, therefore, the following possibilities are provided:
the heating layer is applied to the base member only with the at least one extension in the bent-over state or integrated therein and then the at least one extension is bent over onto the rear side or front side of the base member,
the heating layer is applied to the base member with the at least one extension in the already bent-over state or integrated therein.

Naturally, hybrid types are also conceivable. If, for example, more than one extension is provided, the heating layer could be applied to the base member with one of the extensions in the already bent-over state or be integrated therein and an additional extension could be bent over afterwards.

The possible methods have in common the fact that as a result a base member is provided with a heating layer which has at least one extension which is bent over onto the rear side or front side.

If the at least one extension is bent over onto the rear side of the base member, the extension can abut the front side of the base member or be spaced apart therefrom.

The integration of the heating layer in the base member can be carried out in different manners. For example, the integration can be carried out during an initial shaping method for producing the base member. In a specific example, the heating layer could be injection-molded or back-molded in an injection-molding method for producing the base member

If the at least one extension is bent over onto the rear side, the at least one extension can abut the base member or be spaced apart from the base member.

Conventional contacts (for example, by wire-like conductors which are guided on the rear side) almost unavoidably have, as mentioned, a specific thickness, which is disruptive on the side of the component to be heated. This problem can be elegantly avoided according to the invention by bent-over contacts. In other words, a very thin contacting which is thereby naturally complex to produce on the front side can be avoided by the invention.

In that the at least one extension of the heating layer has - at least substantially - the same basic structure at the edge region of the front side as the remainder of the heating layer, no influence at all or only an extremely small influence on the surface structure of the covering layer can be assumed.

In addition to the fact that the surface structure of the component according to the invention is not disrupted, the component according to the invention can withstand damage and, if damage should nevertheless occur, is easy to repair.

It should be mentioned that the bending over of the extension can also be carried out at an opening in the base component. The internal circumferential region of the opening is then also interpreted to be the front side.

The contacting at the rear side or the front side is also reflected in a higher level of electrical safety against electric shocks and a simpler connection to the electrical power network of the entire arrangement (that is to say, at the system side).

The production method according to the invention has the additional advantage that it is very simple to carry out and therefore with relatively little complexity.

As mentioned, the invention can be used in aircraft construction, but also in ship building or automotive construction and in connection with other industrial applications. Specific examples would be thermoelectrical deicing systems for aircraft, sensor systems, cab heating systems or battery heating systems.

An example of the use of the invention would be heating units for specific components which are used in a cab, for example, of an aircraft, ship, rail vehicle or road vehicle, and which, to this end, can be positioned very near the surface, for example, for the purpose of improved or optimized energy efficiency. This means that the heating can be delimited, for example, only by a thin decorative layer, for example, a film, a layer of leather or a coating, in the direction toward the outer side and, in the ideal case, can ensure a smooth outer face and haptics which are as free from disruptions as possible.

Another example would be heating systems which can be positioned very near the surface, for example, for improved or optimized energy efficiency, wherein at the same time the outer side of the surface can be continuously flat, for example, for technical reasons. For example, a flush closure with respect to a support face can thereby be ensured, as can be advantageous in battery heating systems or in a cab.

In other words, the invention can be used in principle in all situations, wherein the surface structure at a side to be heated (the front side) of the component is the important factor and preferably at the same time an excessively great spacing is not intended to exist between the heating layer and the surface.

As mentioned, a side of the base member which has to be heated and in which a desired (for example, smooth) surface structure has to be achieved is referred to as the front side in the context of the invention, which surface structure must not be impaired or can be impaired only to a minimal extent according to the invention.

The rear side can be understood to be a side facing away from the front side. One or more front sides can be present between the front side and rear side.

In the case of a coarse-surfaced component, the rear side will be the side which faces away from the front side. However, the rear side or the front side can generally be considered to be the side at which the surface structure is of lesser importance.

The base member can itself (at least in regions) be layered and/or flexible. Alternatively or additionally, the base member can at least in regions be a “solid” or hollow (volume) component.

The base member can comprise plastics material or be in the form of a composite plastics component. In the event that the base member is made of metal and/or is conductive, an insulating intermediate layer (or intermediate coating) can be advantageous.

Other intermediate layers between the base member and the heating layer can also be advantageous, for example, for thermal insulation.

Furthermore, optional adhesive layers as intermediate layers are also conceivable.

Intermediate layers can also be advantageous between the heating layer and the covering layer, for example, in order to achieve a particular surface structure.

By the fact that the at least one extension is bent over onto the rear side or the front side of the base component, it can be understood that the at least one extension reaches over to the rear side or the front side in order to be able to produce at that location the electrical contacts for the electrically heatable heating layer.

The bending over must not be carried out only when the heating layer is already on the base member. The at least one extension can also be present in the partially or completely bent-over state and in this form be positioned on the base member.

Furthermore, protection is further provided for an apparatus, in particular an aircraft, a ship or other apparatuses which have, for example, a battery, having a component according to the invention, wherein the heating layer is electrically connected to an electrical network of the apparatus via the contacts.

In specific embodiments of the invention, the base member could also be referred to as a substrate, to which the heating layer is applied.

If the base member is - at least approximately - constructed in a planar manner, the heating layer can be constructed in an extensively or partially covering manner in relation to the base member.

Advantageous further developments of the invention are defined in the dependent claims.

There can be provision for the at least one extension to be bent over from a front side onto the rear side or front side of the base member and/or for the at least one extension, which projects from the base member, to be bent over onto the rear side or front side of the base member.

The heating layer can have a carrier. This carrier constitutes an embodiment of the invention which is particularly simple to produce.

Alternatively, the heating element can be in the form of a printed, conductive layer.

This is particularly the case when the carrier is configured in a flexible manner because then the handling and in particular the bending over can be able to be carried out particularly simply.

However, embodiments are also conceivable according to the invention, wherein the carrier (with the at least one extension) is substantially rigid for the purposes of the production method.

The already-mentioned positioning of the heating layer on the base member, wherein the extension is already in the bent-over state, can then be carried out particularly simply.

There can be provided for the heating layer a conductive paint which is arranged on the carrier and/or the base member. This can be advantageous for further simplification of the production, in particular of the production method according to the invention, because a conductive paint can be applied in a particularly simple manner. This is particularly the case when the carrier or the base member is flexible because the conductive paint can also tolerate deformations after the application.

The conductive paint can be arranged on the carrier over the entire surface, in a grid-like manner, strip-like manner and/or meandering manner.

A comprehensive, grid-like, strip-like or meandering configuration can also be provided for the heating layer when the heating layer is brought about in a manner different from with a conductive paint (for example, by a metal film). The application of the conductive paint to the carrier can be carried out by spraying methods, printing methods (for example, screen printing or offset printing) or direct application (for example, with a paintbrush-like device).

Since the conductive paint can be part of the heating layer or can form the heating layer, there can also alternatively or additionally be provision for the conductive paint to be printed.

The carrier can have a layer made from a film, a textile and/or with a grid carrier.

In particular, the carrier and consequently the heating layer do not have to be a comprehensive layer, but can also have recesses and the like.

The at least one extension can preferably be arranged at one side of the heating layer and extend in particular only over a portion of a length of the side (can also be understood in the sense of an edge).

However, embodiments are also conceivable, wherein the at least one extension extends over the length of a whole side.

There can be provided a single extension, on which two or more contacts for the electrically heatable heating layer are located. Alternatively, one extension per contact can be provided.

A covering layer (for example, a decorative layer) which is preferably arranged on the heating layer or the base layer can be provided.

The covering layer can have a layer of leather, a textile, be in the form of a film, made of wood and/or a metal.

As already mentioned, the covering layer can be arranged on the heating layer, that is to say, the heating layer is then arranged between the base member and the covering layer. In specific embodiments, the covering layer can also be arranged between the base member and the heating layer if the covering layer acts “only” as a covering layer for the base member.

Preferably, the covering layer can be applied after the heating layer to the base member. In other embodiments according to the invention, the heating layer can be applied to the base member as a composite (that is to say, simultaneously) with the covering layer.

The shape of the heating layer and/or the covering layer can be adapted to the front side of the base member or a portion thereof. The contacting can be in the form of a printed contacting and/or an etched and/or soldered contacting.

The contacting can have a strand, a band of solid material and/or a braided band made of a conductive material.

The heating layer and/or the covering layer can be secured to the base member by adhesive bonding, a screwing arrangement and/or clamping.

The securing of the heating layer and the covering layer can be carried out separately or can be released by a common securing member (for example, screwed or clamped).

The heating layer can also be retained on the carrier by the covering layer

### BRIEF DESCRIPTION OF DRAWINGS

Additional advantages and details will be appreciated from the figures and the associated description of the figures. In the drawings:

FIGS. 1a, 1b show a component according to the invention as a sectioned illustration and as a perspective illustration,

FIG. 2a shows a variant of an embodiment of an extension,

FIG. 2b shows another variant of an embodiment of an extension,

FIG. 2c shows yet another variant of an embodiment of an extension, and

FIGS. 3a, 3b show two variants of arrangements of conductive paint on a carrier as a heating layer.

### DETAILED DESCRIPTION OF THE INVENTION

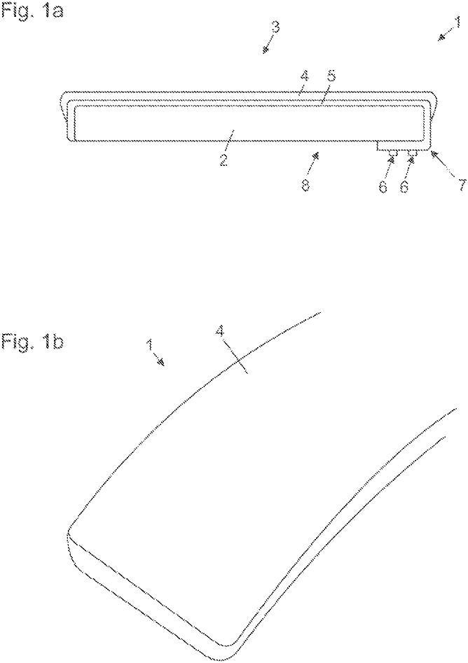

FIG. 1a shows an embodiment of a component 1 according to the invention.

The component 1 has a base member 2, at the front side 3 of which (the side which has to be heated and the surface structure of which is relevant) a heating layer 5 and an (optional) covering layer 4 above.

There is shown an extension 7 which is bent over onto the rear side 8 of the component 1. The bending over is carried out as a (double) bending in this embodiment.

Two contacts 6 which serve to contact the heating layer 5 are located on the rear side 8. By applying an electric voltage across the contacts 6, the heating layer 5 can be heated electrically, for example, by resistance heat of a conductor in the heating layer 4 (that is to say, heat produced by the resistance of the conductor).

FIG. 1b illustrates a perspective view of the component 1 from FIG. 1a toward the front side 3 of the component 1. It can be seen that no influence on the surface of the covering layer 4 is produced at all by the contacting. Consequently, the surface structure of the covering layer 4 is not impaired by the heating layer 5 or the contacting thereof.

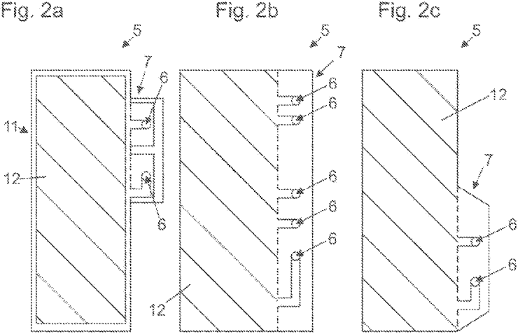

FIGS. 2a to 2c illustrate different possible ways of configuring the at least one extension 7. This extension can extend over the entire edge length of a side of the heating layer 5 or only over a portion thereof.

Naturally, other embodiments are also conceivable, wherein more than one extension 7 is present or one extension extends over a corner.

FIG. 2a further shows that the heating layer can have a carrier 11 and a heating element which is arranged thereon.

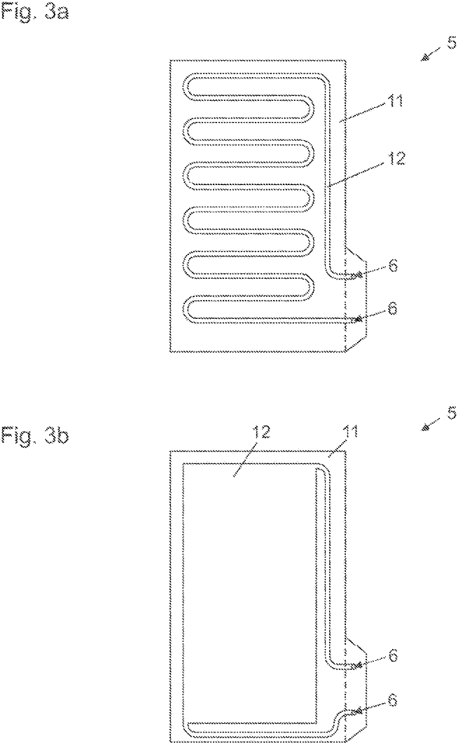

In the embodiment from FIGS. 2a to 2c, the heating element is in the form of a layer of a conductive paint 12. Reference can be made to FIGS. 3a and 3b for possible ways of precisely configuring the arrangement of the conductive paint 12.

FIG. 2b also shows that more than two contacts 6 can be present, for example, in order to achieve a better current supply to the heating element (that is to say, the heating layer) or in order to be able to separately heat different regions of the heating element.

FIG. 3a illustrates a meandering arrangement of the heating element (in this embodiment, a conductive paint 12).

FIG. 3b shows similarly thereto a (substantially) comprehensive arrangement of the conductive paint.

What is claimed is:

1. A heatable component comprising
a base member with an electrically heatable layer for electrically heating the heatable component and
electrical contacts for contacting the electrically heatable heating layer,
wherein the electrically heatable heating layer has at least one extension which is bent over onto a rear side or front side of the base member member and the electrical contacts are arranged at the portion of the at least one extension which is located at the rear side or the front side of the base member member.

2. The heatable component as claimed in claim 1, wherein the at least one extension is bent over from a front side side onto the rear side or front side of the base member or the at least one extension, which projects from the base member, is bent over onto the rear side or front side of the base member.

3. The heatable component as claimed in claim 1, wherein the electrically heatable heating layer has a carrier.

4. The heatable component as claimed in claim 3, wherein the carrier is configured in a flexible manner.

5. The heatable component as claimed in claim 3, wherein the carrier has a layer made from a film, a textile or with a grid carrier.

6. The heatable component as claimed in claim 1, wherein the electrically heatable heating layer has a conductive paint which is arranged on the carrier or the base member.

7. The heatable component as claimed in claim 6, wherein the conductive paint is arranged on the carrier over the entire surface, in a grid-like manner, strip-like manner or meandering manner.

8. The heatable component as claimed in claim 1, wherein the at least one extension is arranged at one side of the electrically heatable heating layer.

9. The heatable component as claimed in claim 1, further comprising a covering layer.

10. The heatable component as claimed in claim 9, wherein the covering layer has a layer of leather, a textile, a film, a wood or a metal.

11. The heatable component as claimed in claim 1, wherein the contacts are in the form of printed contacts, etched or soldered contacts.

12. The heatable component as claimed in claim 1, wherein the (6)contacts have a strand, a band of solid material or a braided band made of a conductive material.

13. The heatable component as claimed in claim 1, wherein the electrically heatable heating layer or the covering layer is secured to the base member by adhesive bonding, a screwing arrangement or clamping.

14. An apparatus comprising
an electrical network,
a heatable component having
a base member with an electrically heatable layer for electrically heating the heatable component and
electrical contacts for contacting the electrically heatable heating layer,
wherein the electrically heatable heating layer has at least one extension which is bent over onto a rear side or front side of the base member and the electrical contacts are arranged at the portion of the at least one extension which is located at the rear side or the front side of the base member,
wherein the electrically heatable heating layer is electrically connected to an electrical network of the apparatus via the contacts.

15. A method for producing a heatable component, wherein
a base member and
an electrically heatable heating layer having at least one extension are provided,
the at least one extension is bent over onto a rear side or a front side of the base member or the electrically heatable heating layer is applied to the base member with the at least one extension in the bent-over state, and
the electrically heatable heating layer is electrically connected at the portion of the at least one extension which is located on the rear side or front side of the base member.

16. (canceled)

17. The heatable component as claimed in claim 1, wherein the at least one extension is bent over from a front side onto the rear side or front side of the base member and the at least one extension, which projects from the base member, is bent over onto the rear side or front side of the base member.

18. The heatable component as claimed in claim 3, wherein the carrier has a layer made from a film, a textile and with a grid carrier.

19. The heatable component as claimed in claim 1, wherein the electrically heatable heating layer has a conductive paint which is arranged on the carrier and the base member.

20. The heatable component as claimed in claim 6, wherein the conductive paint is arranged on the carrier over the entire surface, in a grid-like manner, strip-like manner and meandering manner.

21. The heatable component as claimed in claim 1, wherein the contacts are in the form of printed contacts, etched and soldered contacts.

22. The heatable component as claimed in claim 1, wherein the contacts have a strand, a band of solid material and a braided band made of a conductive material.

23. The heatable component as claimed in claim 1, wherein the electrically heatable heating layer and the covering layer are secured to the base member by adhesive bonding, a screwing arrangement or clamping.

24. The heatable component as claimed in claim 1, wherein the electrically heatable heating layer and the covering layer are secured to the base member by adhesive bonding, a screwing arrangement and clamping.

25. The heatable component as claimed in claim 1, wherein the electrically heatable heating layer or the covering layer is secured to the base member by adhesive bonding, a screwing arrangement and clamping.

26. The method according to claim 15, wherein the electrically heatable heating layer is applied to a front side of the base member.

27. The method according to claim 15, wherein the electrically heatable heating layer is integrated in the base member.
